(19) United States
(12) Patent Application Publication
(10) Pub. No.: US 2007/0257145 A1
(43) Pub. Date: Nov. 8, 2007

(54) Crushing Device

(76) Inventors: Kauko Kinnunen, Jyvaskyla (FI); Hannu Heinasenaho, Jyvaskyla (FI); Hannu Urpalainen, Lahti (FI)

Correspondence Address: Fildes & Outland, 20196 Mack Ave Ste 2, Grosse Pointe Woods, MI, 48236, US

(21) Appl. No.: 11/661,159

(22) PCT Filed: Aug. 22, 2005
(86) PCT No.: PCT/FI05/50296

§ 371 Date: Feb. 22, 2007

(30) Foreign Application Priority Data
Aug. 24, 2004 (FI) 20045304

(51) Int. Cl. B02C 23/02

(52) U.S. Cl. 241/280

(57) ABSTRACT

The invention relates to a crushing device, which includes a frame structure and a rotor mounted rotatably by bearings at its ends to the frame structure. Shredder elements are arranged in connection with both the frame structure and the rotor. At at least one end, a hub motor is connected to the rotor through a planet gearbox. As a continuation of the rotor at the hub-motor end, there is an extension piece, inside which the hub motor is arranged to fit in terms of its length too. The rotor is arranged to be detachable/attachable at its ends over the length of the above or below trough and can be changed through this trough.

The present invention relates to a crushing device, which includes
a frame structure and a rotor mounted rotatably by bearings at its ends to the frame structure,
shredder elements, which are arranged in connection with both the frame structure and the rotor, in such a way that the frame structure and the rotor together form a crushing throat and the frame structure is bounded by troughs above and below the rotor,
a hub motor fitted to at least one end to rotate the rotor, and
   the material fed to the upper trough is arranged to travel through the shredder elements in the throat while at the same time being crushed into smaller pieces when the rotor rotates, and to exit trough the lower trough.

Crushing devices, such as a shredder are used, for example, to crush municipal waste or car tyres. A crushing device has at least one generally slowly rotating rotor, in which there are shredder elements to create a crushing effect. To achieve a suitable rotation speed, the crushing device generally has a planet gearbox containing gears, to which a hydraulic motor is connected. Electric motors can also be used, though a hydraulic motor will withstand large loading variations better than an electric motor. In practice, the rotor may even stop completely, which would cause problems in an electric-motor drive. The material is usually fed to the shredder from above while the crushed material falls below the shredder by gravity. The motor together with the gearbox is a so-called hub motor at the end of the rotor, so that most of the hub motor remains inside the rotor.

U.S. Pat. No. 5,052,630 discloses a shredder, in which various blades are fitted next to each other on a shaft, to form the rotor. The shaft itself is supported at both ends on large bearings in the frame structure of the shredder. In addition, a hydraulic motor is connected as a continuation of the shaft through a rigid clutch. The frame structure forms a throat, in which the rotor formed from the blades is located. In addition, counter-blades are fitted to both sides of the throat. Thus the drum can be rotated in both directions while crushing the material between the blades and the counter-blades.

In the shredder described above, as in other known shredders, the changing of the rotor is a labourious and difficult operation. In process conditions, the crusher is part of the logistics chain and the interruption of its operation for the duration of the changing of the rotor is particularly damaging, because the operation of the entire chain is stopped. On the other hand, in various contracting applications the rotor is changed to correspond to the material being crushed. There has been no solution on the market for changing the rotor rapidly.

The invention is intended to create a new type of crushing device, the construction of which will permit the rapid changing of the rotor. The characteristic features of the present invention appear in the accompanying Claims. In the crushing device according to the invention, an extension piece installed in the hub-motor side of the crushing device permits the rotor to be changed easily, as the hub motor itself no longer extends inside the rotor and is thus not in the way when the rotor is changed in the radial direction.

In the following, the invention is examined in detail with reference to the accompanying drawings showing some embodiments of the invention.

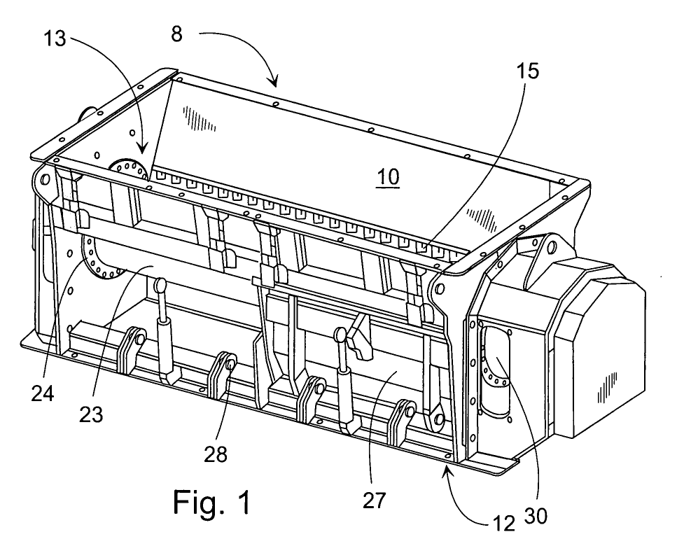

FIG. 1 shows an axonometric view of the shredder according to the invention partially dismantled,

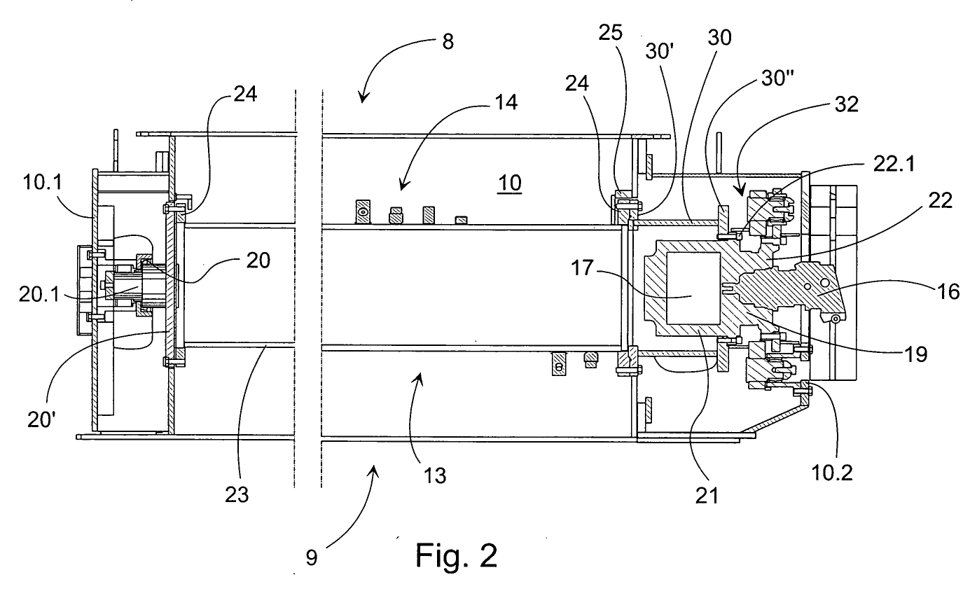

FIG. 2 shows a cross-section of the shredder of FIG. 1,

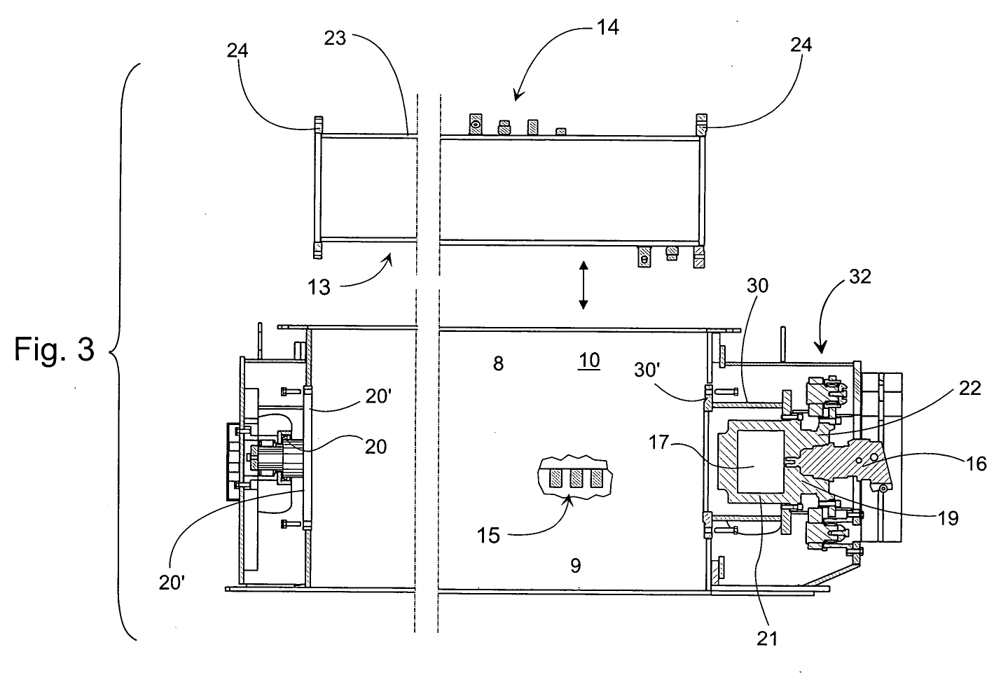

FIG. 3 shows the shredder of FIG. 2 with the rotor detached,

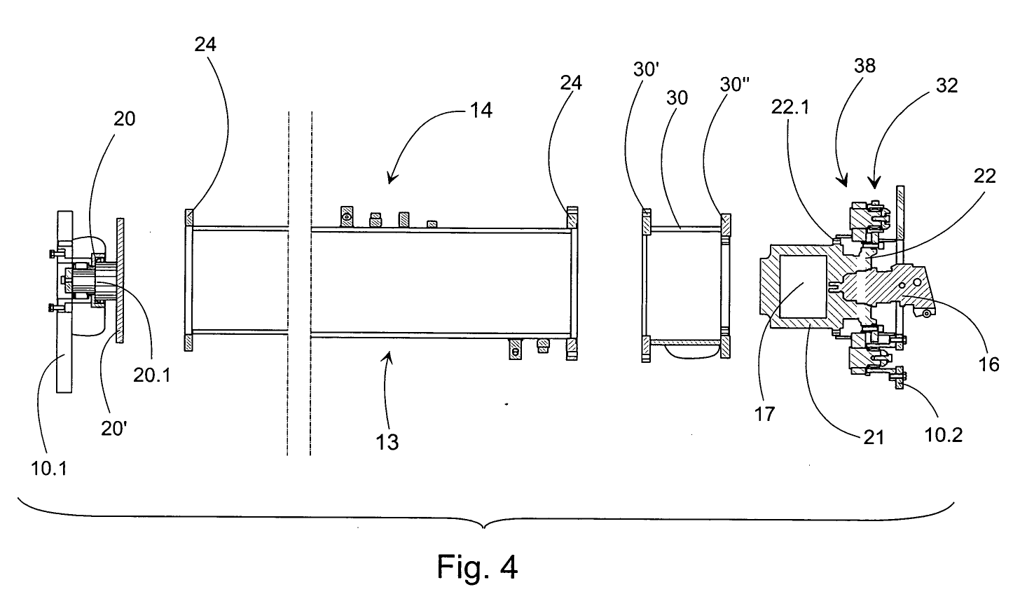

FIG. 4 shows the shredder of FIG. 2 with the rotor and its support components detached from each other,

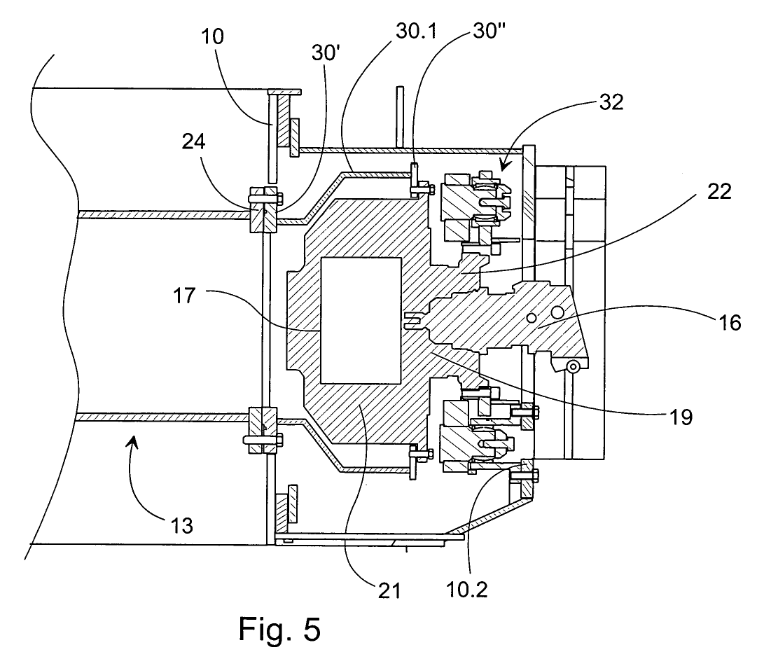

FIG. 5 shows a second shredder equipped with a high power transmission.

FIG. 1 shows the crushing device according to the invention without ancillary devices. The second wall element of counter blades has been removed. The frame structure 10 of the shredder is principally manufactured from steel tubes and plates and is open from its upper and lower parts, thus forming a feed trough 8 above and an outlet trough 9 below. The frame structure 10 also includes attachment lugs 11 and 12 in both the upper and lower parts, for fitting the shredder as part of a larger apparatus. In practice, a feed funnel is attached to the upper part of the frame structure 10 and an outlet funnel (not shown) correspondingly to the lower part. In addition to the various funnels and possible conveyors, the shredder includes a control system and a power source, which is connected to the power transmission package according to the invention. Depending on the application, the shredder is either fixed or mobile.

A rotor 13, which is attached rotatably by bearings at its ends to the frame structure 10, forms an essential part of the shredder. In the rotor, there are first shredder elements 14 and second shredder elements 15, i.e. counter blades fixed attached to the frame. The power source used can be selected case-specifically, but the rotor is preferably rotated by a hydraulic motor, which is fitted to the power transmission package. Thus, for example, a diesel engine is used to drive a hydraulic pump, which rotates a hydraulic motor. This is connected to the rotor 13 through a planet gearbox 17 and an extension piece 30. Alternatively, a low-speed hydraulic motor can be used (not shown). In practice, the material fed to the shredder travels through the shredder elements 14 and 15 while at the same time being crushed into smaller pieces when the rotor 13 is rotated by the hydraulic motor 16.

The counter blades, i.e. the shredder elements 15 are attached to the wall element 27 by bolt joints. Each blade element can be rotated through 180° and refurbished by hard surfacing. The wall element 27 is attached to the frame by a hinge joint 28. It can be opened and closed by hydraulic cylinders and is locked by hydraulically operated locking pins (not shown).

According to the invention, the plant gearbox 17 driven by the hub motor 19 at at least one end of the rotor 13 is located inside the said extension piece 30, FIG. 2. At its ends, the rotor 13 includes end flanges 24, the outer dimension of which is slightly less that the dimension of the feed trough 8, nor does the planet gearbox 17 extend inside the rotor 13. The radial end flanges 24 can thus be detached from the counter—flanges 20′ and 30′ and the rotor 13 can be lifted out through the feed trough 8 and set back in place in the reverse sequence. This permits the rapid changing of the rotor 13 and the shredder elements in general.

The planet gearbox 17 is preferably arranged as a hub motor 19 containing a reduction gear train, to which a high speed hydraulic motor 16 is connected. The construction in question is compact, so that the power transmission package requires only a little installation space. Most of the hub motor is placed inside the extension piece 30, but does not extend into the area of the rotor.

In the embodiment of FIG. 2, the power transmission package is only at one end of the rotor. At the other end of the rotor there is a conventional bearing arrangement (a ball-like roller bearing), in which the bearing 20 supports the shaft 20.1 to which the flange 20′ is attached. The rotor 13 is attached to this by its end flange 24, using a bolt joint. In addition, the feed trough is dimensioned to be slightly longer than the rotor 13. Thus the rotor can be detached from the shredder, without detaching the bearings, according to FIG. 3. The construction of the shredder is thus modular, which makes it easy to manufacture shredders of different power and to utilize the same components. Power transmission packages can be used at both ends. In addition to increasing power, the use of a power transmission package at both ends of the rotor can be used to maximize the length of the shredder's life. Further, the capacity of the shredder can be increased by fitting two essentially similar rotors parallel to each longitudinally (not shown). In that case, the shredder will include two or four hub motors. As many as three parallel rotors can be used.

The rotor 13 is formed mainly from a tube 23, which achieves a light but stiff structure. In addition, the interior of the tube can be utilized by arranging a medium filling and/or circulation in it, in order to cool the rotor of the hub motor.

It is preferable to use bolt joints to attach the rotor. In addition, the rotor and the frame structure are dimensioned in such a way that by opening the screw joints the rotor can be lifted away from the shredder, without detaching or moving the bearing arrangement or power transmission. The construction is user-friendly and speeds up servicing. In the shredder it is also possible to rapidly change rotors equipped with different kinds of blade pieces, if the work demands this. In addition, by increasing the size of the extension piece, even a large hub motor can be fitted to the end of a rotor that is of an advantageous size in terms of crushing, which will be described later.

In practice, the hub motor 19 includes a case 21, which contains the gear wheels of the planet gearbox. There is a flange 22 in the hub motor, by means of which the hub motor is attached to the frame, preferably with the aid of a pivot joint 32. This attachment method is not essential to this invention. The second, rotating flange 22.1 of the hub motor 19 is attached to the flange 30″ of the extension piece 30.

Between the case 21 and the flange 22, there are also the bearings (not shown) of the hub motor which support also the rotor. In other words, the flange and the case rotate relative to each other. In the embodiments shown, the case 21 is connected to the rotor 13 and the flange 22 to the frame structure 10 with the aid of the pivot joint 32 that permits a variation in angle. If necessary, the hub motor can be arranged the other way round. In principle, the hub motor can be attached rigidly to both the rotor and the frame structure. In that case, however, the deflections of the frame and the rotor will strain the bearings of the hub motor and the manufacturing tolerances will be also small. This is because during crushing the frame and the rotor will unavoidably deflect to some extent and/or there will be errors of angle in the manufacture, when too great a strain will be placed on the bearings of the hub motor.

According to FIG. 4, the rotating components between the fixed supports are as follows from left to right: Fixed end plate 10.1 of the frame, bearing 20, shaft 20.1 with flange 20′ in it, rotor 13, extension piece 30, hub motor 17, pivot joint 32, and opposite fixed end plate 10.2 of the frame. The extension piece 30 comprises a tube 30.1 and flanges 30′, 30″.

FIG. 5 shows an adaptation of the shredder, in which the same reference numbers as above are used for components that are functionally similar. Such an adaptation is required, for example, when it is wished to increase the crushing power by increasing the torque or the drive power in general. A higher power transmission will not necessarily fit inside an extension piece with a diameter that is equal to the diameter of the shedder drum. Thus, the diameter of the shredder drum can be kept as it way, if an extension piece 30 equipped with a widening is used, as shown in FIG. 5. A power transmission of a considerably higher power, particularly a plant-gear transmission 17, will now fit inside the tube 30.1 of the extension piece 30.

As can be seen from the above examples, the extension piece according to the invention permits the use of a considerably more versatile shredder than that is possible in known shredders. In addition to being able to change the shredder elements rapidly, the same frame permits the use of power transmission packages of different power.

1. Crushing device, which includes
a frame structure and a rotor mounted rotatably by bearings at its ends to the frame structure,
shredder elements, which are arranged in connection with both the frame structure and the rotor, in such a way that the frame structure and the rotor together form a crushing throat and the frame structure is bounded by troughs above and below the rotor,
a hub motor fitted to at least one end to rotate the rotor, and
the material fed to which upper trough is arranged to travel through the shredder elements in the throat while at the same time being crushed into smaller pieces when the rotor rotates, and to exit through the lower trough, characterized in that, as a continuation of the rotor at the hub-motor end, there is an extension piece, inside which the hub motor is arranged to fit in terms of its length too, and that the rotor is arranged to be detachable/attachable at its ends over the length of the selected trough and can be changed through this trough.

2. Crushing device according to claim 1, characterized in that at at least one end of the rotor there is a radial flange, by which it is attached using axial bolts to a corresponding flange of the said extension piece.

3. Crushing device according to claim 1, characterized in that at the opposite end to the hub motor the rotor is supported with the aid of a self-aligning bearing.

4. Crushing device according to claim 1, characterized in that both ends of the rotor include extension pieces and hub motors attached to them.

5. Crushing device according to claim 1, characterized in that the extension piece comprises a tube and flanges at its ends.

6. Crushing device according to claim 5, characterized in that in the said tube there is widening for a planet gearbox with a diameter that is greater than that of the rotor.

7. Crushing device according to claim 1, characterized in that hub motor is connected to the rotor through a planet gearbox.

8. Crushing device according to claim 2, characterized in that at the opposite end to the hub motor the rotor is supported with the aid of a self-aligning bearing.

9. Crushing device according to claim 2, characterized in that both ends of the rotor include extension pieces and hub motors attached to them.
